(19) United States
(12) Patent Application Publication
(10) Pub. No.: US 2023/0222293 A1
(43) Pub. Date: Jul. 13, 2023

(54) SYSTEMS AND METHODS FOR GENERATING A USER ACKNOWLEDGMENT

(71) Applicant: Capital One Services, LLC, McLean, VA (US)

(72) Inventors: Kate Key, Powhatan, IL (US); Jeremy Edward Goodsitt, Champaign, VA (US); Stephen Caleb Holton, Richmond, VA (US)

(21) Appl. No.: 17/572,571

(22) Filed: Jan. 10, 2022

(51) Int. Cl. G06F 40/35; H04L 51/02

(52) U.S. Cl. CPC G06F 40/35; H04L 51/02; G06N 20/00

(57) ABSTRACT

Disclosed embodiments may include a method for creating a user acknowledgement using utterances or text data received by a response generation system. After processing the utterances or text data to determine what the user has stated, the system may then determine whether a user is expressing a certain sentiment that would create a need to send a user acknowledgement. When this occurs, the system creates one or more personalized responses to the user based on stated information or user profile information and then presents those responses to an agent. The system then sends the response chosen by the agent to the user.

The disclosed technology relates to systems and methods for generating a user acknowledgement. Specifically, this disclosed technology relates to determining whether a user has a certain sentiment and, if the user has the certain sentiment, generating an appropriate response to that sentiment.

### BACKGROUND

Many companies want to send customers acknowledgements when the customer is going through specific life events. This can help the user to feel recognized by the company and, in turn, the company retains the user's business in the future. For example, a company may find out during a customer service call that a user recently experienced a death in their immediate family. The company can show their appreciation for that customer by sending the customer a card after the call to express condolences. Thus, user acknowledgements are important to retaining customers and maintaining good relations with the user.

Traditional systems and methods for generating user acknowledgements typically require a call center representative to identify that the user is having a certain life event, then pick out a user acknowledgment, and send it to the user. These steps take a significant amount of time for the call center representative to complete, which lowers their call efficiency and therefore increases the cost associated with the call. This increase in time also disrupts call center metrics.

Accordingly, there is a need for improved systems and methods for identifying user sentiment and generating user acknowledgments. Embodiments of the present disclosure are directed to this and other considerations.

### SUMMARY

Disclosed embodiments may include a system for generating user acknowledgements. The system may include one or more processors, and memory in communication with the one or more processors and storing instructions that, when executed by the one or more processors, are configured to cause the system to perform a method for generating a user acknowledgement. The method may include receiving, from a user device (e.g., a phone), one or more first utterances. For example, the method may include generating, using natural language processing (NLP), language data from the one or more first utterances. The method may include generating, using a first machine learning model (MLM), a first sentiment (e.g., an indication of a major life event) based on the language data. In one example, the method may include determining whether the first sentiment requires one or more responses (e.g., sending a card) from a plurality of responses. If so, in another example, the method may include selecting, using a second MLM, the one or more responses from the plurality of responses (e.g., a choice of multiple different cards to send) based on the first sentiment. The method may include generating, using the second MLM, one or more personalized responses from the one or more responses based on the first sentiment. For example, the method may also include sending the one or more personalized responses to an agent device for display for an agent to select a first personalized response. In one example, the method may include sending the first personalized response selected by the agent.

Disclosed embodiments may include a system for generating user acknowledgements. The system may include one or more processors, and memory in communication with the one or more processors and storing instructions that, when executed by the one or more processors, are configured to cause the system to perform a method for generating a user acknowledgement. The method may include receiving, from a user device (e.g., a phone), one or more first text data (e.g., text messages or a chat application). For example, the method may include generating, using NLP, language data from the one or more first text data. The method may include generating, using a first MLM, a first sentiment (e.g., an indication of a major life event) based on the language data. In one example, the method may include determining whether the first sentiment requires one or more responses (e.g., sending a card) from a plurality of responses. If so, in another example, the method may include selecting, using a second MLM, the one or more responses from the plurality of responses (e.g., a choice of multiple different cards to send) based on the first sentiment. The method may include generating, using the second MLM, one or more personalized responses from the one or more responses based on the first sentiment. For example, the method may also include sending the one or more personalized responses to an agent device for display for an agent to select a first personalized response. In one example, the method may include sending the first personalized response selected by the agent.

Disclosed embodiments may include a system for generating user acknowledgements. The system may include one or more processors, and memory in communication with the one or more processors and storing instructions that, when executed by the one or more processors, are configured to cause the system to perform a method for generating a user acknowledgement. The method may include receiving, from a user device associated with a user, one or more first utterances (e.g., a voice call). In one example, the method may include generating, using NLP, language data from the one or more first utterances. In another example, the method may include generating, using a first MLM, a first sentiment (e.g., an indication of a major life event) based on the language data. For example, the method may include selecting, using a second MLM, one or more responses (e.g., a greeting card) from a plurality of responses (e.g., a choice of multiple different cards to send) based on the first sentiment. The method may also include generating, using the second MLM, one or more personalized responses from the one or more responses based on the first sentiment. In one example, the method may include selecting a first personalized response. Finally, the method may include sending the first personalized response.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for generating a user acknowledgement in accordance with certain embodiments of the disclosed technology.

FIG. 2 is a flow diagram illustrating an exemplary method for generating a user acknowledgement in accordance with certain embodiments of the disclosed technology.

FIG. 3 is block diagram of an example response generation system used to determine if a response is needed and determine an appropriate response, according to an example implementation of the disclosed technology.

FIG. 4 is block diagram of an example system that may be used to determine if a response is needed and generate an appropriate response, according to an example implementation of the disclosed technology.

FIG. 5 is a flow diagram illustrating an exemplary method for generating a user acknowledgement in accordance with certain embodiments of the disclosed technology.

### DETAILED DESCRIPTION

Examples of the present disclosure relate to systems and methods for generating user acknowledgements. More particularly, the disclosed technology relates to determining whether a user is exhibiting a certain sentiment, or feeling, that occurs in response to experiencing a major life event and creating a customized user acknowledgement specific to the life event that the call center operator can send to the user if appropriate. The systems and methods described herein are necessarily rooted in computer and technology as they relate to dynamically determining a user's sentiment and determining how to respond appropriate to that sentiment, whether in sending a greeting card, flowers, or chocolates. In some instances, the system utilizes a machine learning model to determine what sentiment the user is expressing. Machine learning models are a unique computer technology that involves training the models to complete tasks, such as labeling, categorizing, or determining whether a user's user interaction data (e.g., expressing sadness from a death in the immediate family) is associated with a particular sentiment type so the machine learning models learn how to label, categorize, or determine a particular sentiment type. Importantly, examples of the present disclosure improve the speed with which computers can determine a sentiment and generate the appropriate response to the sentiment based on the determination.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

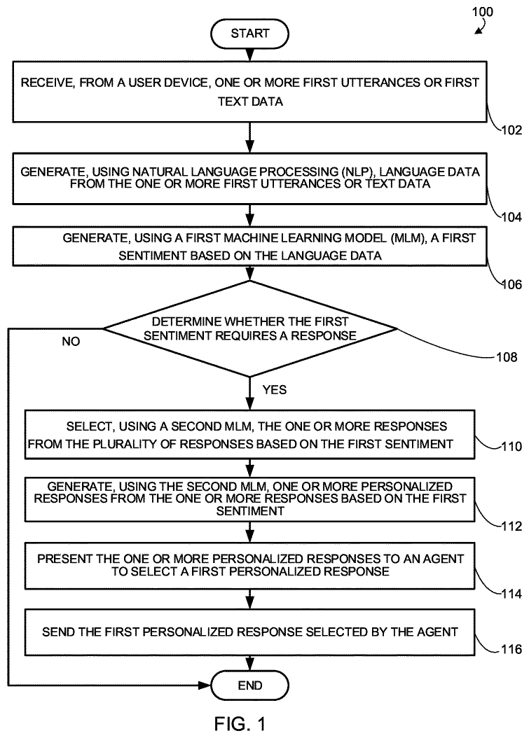

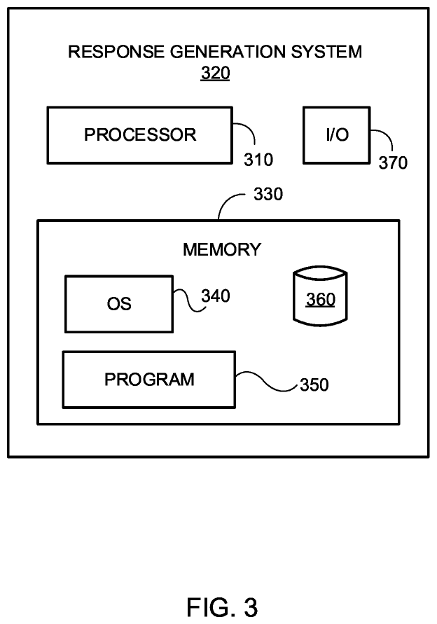

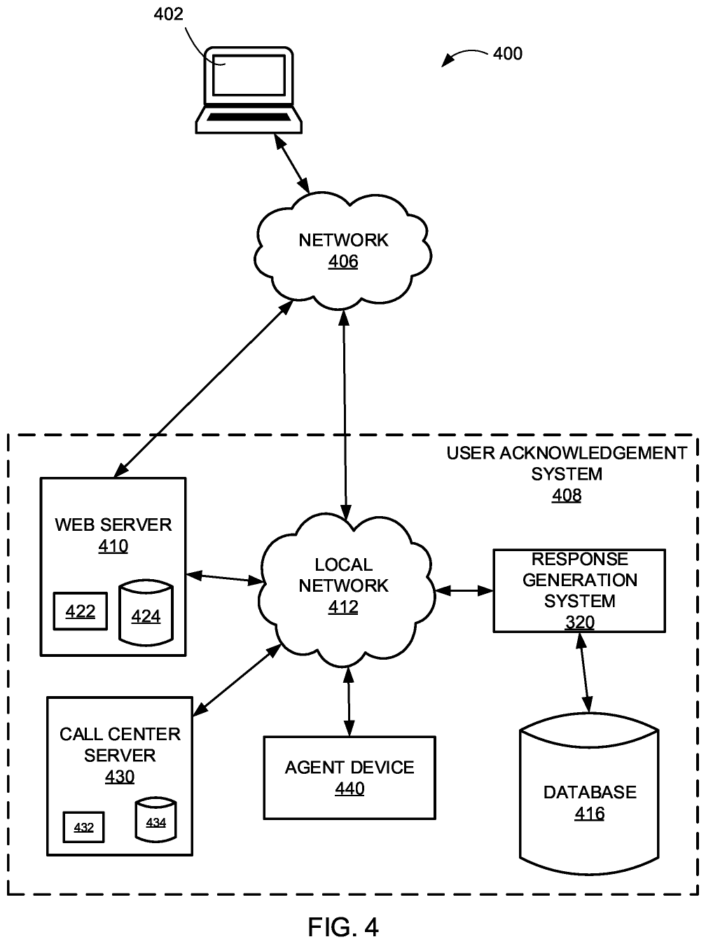

FIG. 1 is a flow diagram illustrating an exemplary method 100 for method for generating a user acknowledgement, in accordance with certain embodiments of the disclosed technology. The steps of method 100 may be performed by one or more components of the system 400 (e.g., response generation system 320 or web server 410 of user acknowledgement system 408 or user device 402), as described in more detail with respect to FIGS. 3 and 4.

In block 102, the response generation system 320 may receive text or voice data (e.g., speech/utterances, chat messages, or text messages) associated with user using a user device 402 (e.g., phone or a computer). This may occur when the user calls a customer service line in order to speak with a customer service representative. The response generation system 320 may also continue to receive additional text or voice data as the call or text conversation continues.

In block 104, the response generation system 320 may generate language data from the text or voice data received in block 102. The language data may be created using natural language processing using a learning model or in response to specific recognized key words (e.g., died, birth, born, graduation, anniversary, celebrate). This recognition may occur while the user in on the phone, or the chat is open, or after the duration of the phone call or chat. If the response generation system 320 is busy at the time of the call or chat, the call or chat may be recorded and stored. The response generation system 320 may then access the stored call or chat data and generate the language data after the duration of the phone call or chat.

In block 106, the response generation system 320 may, using the language data generated in block 104, generate a sentiment regarding the user using an MLM. The MLM may compare the language data to known situations in training language data. Training language data may include simulated or mock data or real recorded conversations of common triggering life events. Known situations may include a birth, death, loss of job, birthday, anniversary, graduation, illness, major purchase (e.g., home or car), holiday, or cultural or religious day of significance. Furthermore, another known situation may be the user's close proximity to unexpected world events (e.g., hurricane, major accident, attack). The sentiment for the user may be related to the user's emotions, feelings, mood, or mental state. Furthermore, the sentiment may be related to the user expressing a traumatic or major life event such as a death in the family, a graduation, a marriage, or the birth of a child. For example, if a user calls and mentions that they are behind on payments because their father just died, the response generation system 320 would determine that the user has experienced a death in the family. Furthermore, the response generation system 320 may consider past data regarding the user. The response generation system 320 may also include a user profile that contains records of past sentiments that the user has expressed on prior phone calls or text conversations. The first MLM may recall and use the record of past sentiments and other records from the user profile when generating a new sentiment. For example, if on a previous call, the user mentioned that she was pregnant and on the second call the user mentions that she had given birth, the response generation system 320 could recall the prior sentiment created during the prior call regarding the pregnancy and link the second sentiment with the first sentiment regarding having given birth on the present call. Records may include signals that were made previously that may help change sentiment predictions. For example, if the user disliked a specific response, the first MLM of the response generation system 320 may attribute that past sentiment negatively based on the sentiment of the current call.

In block 108, the response generation system 320 may determine whether the detected sentiment requires a response. Using an MLM, which may be the first MLM, the response generation system 320 may decide, based on the sentiment or the language data, that a response is not necessary (e.g., the user is discussing in passing that his neighbor's extended relative died on the call). If a response is not necessary, the response generation system 320 ends the investigation of that sentiment. The response generation system 320 may record the generation of the sentiment and store that information in the user profile or the sentiment may be deleted. If the response generation system 320 determines that a response is necessary, then the method proceeds to block 110. Factors used by the response generation system 320 to determine if a response is necessary may include, but is not limited to, intonation information in the language data, metrics measuring excitement, and information hinting at the severity of a user's problem. In some embodiments (e.g., method 200), block 108 or its equivalents may be optional. In that case, response generation system 320 may skip determining if a response is needed and go straight from generating a sentiment to selecting a response for that sentiment. The determination step may be completed by the first MLM after the first MLM has generated a first sentiment. Alternatively, the first MLM, in lieu of generating a first sentiment, may directly determine whether a response is required without generating a sentiment (e.g., method 500).

In block 110, the response generation system 320 may select a response from a plurality of available responses according to the first sentiment. This selection may be completed by a second MLM or the same MLM that generates a sentiment. For example, if the sentiment generated is that it is the user's 30^{th} wedding anniversary, the response generation system 320 will look at available anniversary responses to send the user. These responses may be care packages and may include gifts of cards, chocolates, or flowers. The response generation system 320 may have an assortment of options of responses. For example, the response generation system 320 may be able to choose between multiple types of flowers, between different types of chocolate, or between a large selection of different greeting cards. The second MLM of the response generation system 320 may also look at associated user profile that has been compiled on the customer. The user profile may contain information about the user's preferences, including transaction data from a user's credit card (e.g., a user's transaction data shows several purchases from a chocolate shop, implying that the user likes chocolate). This transaction data may include information regarding a user's total expenditures on a credit card within the last year to aid in determining an appropriate response. This transaction data can then be used to determine potential preferences about the user (e.g., the type of chocolate the user likes or their favorite flower). The user profile may also contain information about previous responses that have been sent to the user. This information regarding previous responses may be used to aid the call center agent in selecting the response or aid the MLM in generating a response. The second MLM of response generation system 320 may be programmed to make a response selection different than or the same as a response that was selected for the user before. The second MLM of the response generation system 320 may also consider previous responses for budget tracking and to elicit improved responses from the system in the future. The response generation system 320 may look at prior sentiments in making a selection in addition to looking at the current sentiment. Furthermore, the response generation system 320 may select more than one response based on the sentiment. The response generation system 320 may also generate responses based on a second or third detected sentiment (e.g., 30^{th} wedding anniversary and wife's birthday).

In block 112, the response generation system 320 generates a personalized response from the one or more responses using the second MLM. Once the response generation system 320 has selected a response or responses based on the sentiment from the plurality of sample responses, the MLM will personalize the response to the user. This may involve, in the case of a greeting card, adding the user's name, a specialized message to that user, or a graphic. As with block 110, the response generation system 320 may also pull from information in the user's associated user profile to better personalize the response. For example, if the user is experiencing their 30^{th} wedding anniversary, the response generation system 320 may pull the information from the information on the user profile regarding the user's spouse. The response generation system 320 then may generate text on a card to the user specifying the name of the user's spouse (e.g., Dear Martha, Congratulations on 30 years of marriage to John!). The response generation system 320 may change other attributes of the response based on known preferences, such as color, taste, and sound. Known preferences may be provided using information from the user profile or information based on the transaction history of the user. Furthermore, the response generation system 320 may generate more than one personalized response based on the sentiment.

In block 114, the response generation system 320 presents the response or more than one response to an agent. The agent could be a call center agent, a company representative, or other company employee. The response generation system 320 may present the response to the agent via a computer, or customized graphical user interface (GUI). The GUI may be setup to display one or more response options (e.g., 3 different card variations, or 2 card options and a flower option). The second MLM may be configured to create several different responses and rank the responses according to their likely match to the user's preferences. The GUI may be designed to present the personalized responses to the agent in their ranked order. The GUI may also present the personalized responses sorted by cost. The ranking may also be specified by other data in the user's profile, such as the annual expenditures on the user's credit card or responses to surveys or questionnaires. The GUI may allow the agent to modify the response. Furthermore, the GUI may contain an option to allow the agent to not send a response.

In block 116, the response generation system 320 sends the personalized response selected by the agent. The agent may be able to select the personalized response to send, selected from multiple personalized responses, or select not to send a personalized response. If the agent chooses to send a personalized response, the response generation system 320 may send the card using appropriate means. This may include interfacing with a networked printer or 3^{rd} party company to print and send the card, a florist to send flowers, or a chocolatier to send chocolates with a personalized note. In some embodiments, the personalized message may be sent to a user device 402 associated with the user via text message, push notification, email, or other message from the response generation system 320. The selection information about which response the agent chose may be returned to the first or second MLM in order to train or modify the MLM. This information may be used by the MLM to make more intelligent choices about responses over time.

The first and second MLMs may be embodied in one MLM. This may be completed by using a single MLM with different algorithms completing the steps recited in blocks 106, 108, 110 and 112. In such an embodiment, the flow and alteration of data would be effectively the same as illustrated by FIG. 1.

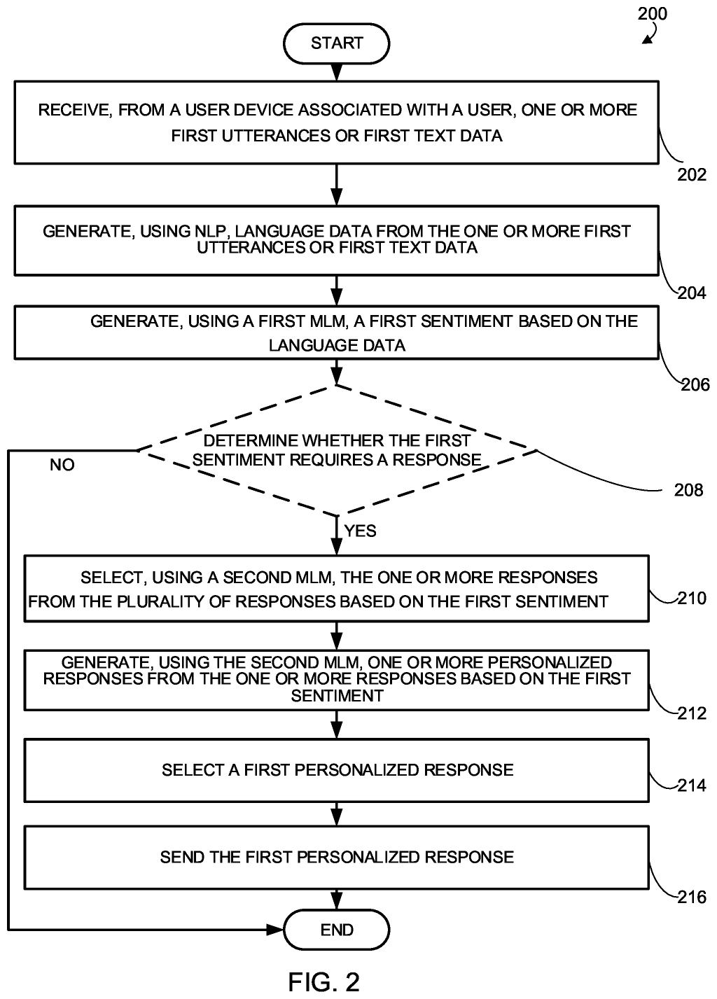

FIG. 2 is a flow diagram illustrating an exemplary method 200 for generating a user acknowledgement, in accordance with certain embodiments of the disclosed technology. The steps of method 200 may be performed by one or more components of the system 400 (e.g., response generation system 320 or web server 410 of user acknowledgement system 408 or user device 402), as described in more detail with respect to FIGS. 3 and 4.

Method 200 of FIG. 2 is similar to method 100 of FIG. 1, except that method 200 may not include blocks 108 or 114 of method 100. The descriptions of blocks 202, 204, 206, 208, 210, 212, and 216 in method 200 are similar to the respective descriptions of blocks 102, 104, 106, 108, 110, 112, and 116 of method 100 and are not repeated herein for brevity. However, block 214 is different from block 114 and is described below.

In block 214, the response generation system 320 selects a personalized response. This may be completed by the second MLM or by a different method. In this case, instead of using the agent to select a specific response (as in method 100), the response generation system 320 selects the response on its own. The selection process may be decided by cost, information in the user profile, or other information specified such as the number of years the user has been a customer, the user's spending habits, or company budgetary restrictions.

FIG. 3 is a block diagram of an example response generation system 320 used to determine the sentiment of a user and generate the appropriate response to the sentiment according to an example implementation of the disclosed technology. According to some embodiments, the user device 402 and web server 410, as depicted in FIG. 4 and described below, may have a similar structure and components that are similar to those described with respect to response generation system 320 shown in FIG. 3. As shown, the response generation system 320 may include a processor 310, an input/output (“I/O”) device 370, a memory 330 containing an operating system (“OS”) 340 and a program 350. In certain example implementations, the response generation system 320 may be a single server or may be configured as a distributed computer system including multiple servers or computers that interoperate to perform one or more of the processes and functionalities associated with the disclosed embodiments. In some embodiments response generation system 320 may be one or more servers from a serverless or scaling server system. In some embodiments, the response generation system 320 may further include a peripheral interface, a transceiver, a mobile network interface in communication with the processor 310, a bus configured to facilitate communication between the various components of the response generation system 320, and a power source configured to power one or more components of the response generation system 320.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 310 to communicate with other devices via wired or wireless networks, whether local or wide area, private or public, as known in the art. A power source may be configured to provide an appropriate alternating current (AC) or direct current (DC) to power components.

The processor 310 may include one or more of a microprocessor, microcontroller, digital signal processor, co-processor or the like or combinations thereof capable of executing stored instructions and operating upon stored data. The memory 330 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 330.

The processor 310 may be one or more known processing devices, such as, but not limited to, a microprocessor from the Pentium™ family manufactured by Intel™ or the Turion™ family manufactured by AMD™. The processor 310 may constitute a single core or multiple core processor that executes parallel processes simultaneously. For example, the processor 310 may be a single core processor that is configured with virtual processing technologies. In certain embodiments, the processor 310 may use logical processors to simultaneously execute and control multiple processes. The processor 310 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the response generation system 320 may include one or more storage devices configured to store information used by the processor 310 (or other components) to perform certain functions related to the disclosed embodiments. In one example, the response generation system 320 may include the memory 330 that includes instructions to enable the processor 310 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, the response generation system 320 may include a memory 330 that includes instructions that, when executed by the processor 310, perform one or more processes consistent with the functionalities disclosed herein. Methods, systems, and articles of manufacture consistent with disclosed embodiments are not limited to separate programs or computers configured to perform dedicated tasks. For example, the response generation system 320 may include the memory 330 that may include one or more programs 350 to perform one or more functions of the disclosed embodiments. For example, in some embodiments, the response generation system 320 may additionally manage dialogue and/or other interactions with the customer via a program 350.

The processor 310 may execute one or more programs located remotely from the response generation system 320. For example, the response generation system 320 may access one or more remote programs that, when executed, perform functions related to disclosed embodiments.

The memory 330 may include one or more memory devices that store data and instructions used to perform one or more features of the disclosed embodiments. The memory 330 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 330 may include software components that, when executed by the processor 310, perform one or more processes consistent with the disclosed embodiments. In some embodiments, the memory 330 may include a response generation database 360 for storing related data to enable the response generation system 320 to perform one or more of the processes and functionalities associated with the disclosed embodiments.

The response generation database 360 may include stored data relating to status data (e.g., average session duration data, location data, idle time between sessions, and/or average idle time between sessions) and historical status data. According to some embodiments, the functions provided by the response generation database 360 may also be provided by a database that is external to the response generation system 320, such as the database 416 as shown in FIG. 4.

The response generation system 320 may also be communicatively connected to one or more memory devices (e.g., databases) locally or through a network. The remote memory devices may be configured to store information and may be accessed and/or managed by the response generation system 320. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The response generation system 320 may also include one or more I/O devices 370 that may comprise one or more interfaces for receiving signals or input from devices and providing signals or output to one or more devices that allow data to be received and/or transmitted by the response generation system 320. For example, the response generation system 320 may include interface components, which may provide interfaces to one or more input devices, such as one or more keyboards, mouse devices, touch screens, track pads, trackballs, scroll wheels, digital cameras, microphones, sensors, and the like, that enable the response generation system 320 to receive data from a user (such as, for example, via the user device 402).

In example embodiments of the disclosed technology, the response generation system 320 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

While the response generation system 320 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the response generation system 320 may include a greater or lesser number of components than those illustrated.

FIG. 4 is a block diagram of an example system that may be used to route an incoming call and create a response following a call, according to an example implementation of the disclosed technology. The components and arrangements shown in FIG. 4 are not intended to limit the disclosed embodiments as the components used to implement the disclosed processes and features may vary. As shown, user acknowledgement system 408 may interact with a user device 402 via a network 406. In certain example implementations, the user acknowledgement system 408 may include a local network 412, a response generation system 320, a web server 410, and a database 416.

In some embodiments, a user may operate the user device 402. The user device 402 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 406 and ultimately communicating with one or more components of the user acknowledgement system 408. In some embodiments, the user device 402 may include or incorporate electronic communication devices for hearing or vision impaired users.

Users may include individuals such as, for example, subscribers, clients, prospective clients, or customers of an entity associated with an organization, such as individuals who have obtained, will obtain, or may obtain a product, service, or consultation from or conduct a transaction in relation to an entity associated with the user acknowledgement system 408. According to some embodiments, the user device 402 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The network 406 may be of any suitable type, including individual connections via the internet such as cellular or WiFi networks. In some embodiments, the network 406 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 406 may include any type of computer networking arrangement used to exchange data. For example, the network 406 may be the Internet, a private data network, virtual private network using a public network, and/or other suitable connection(s) that enable(s) components in the system 400 environment to send and receive information between the components of the system 400. The network 406 may also include a public switched telephone network (PSTN) and/or a wireless network.

The user acknowledgement system 408 may be associated with and optionally controlled by one or more entities such as a business, corporation, individual, partnership, or any other entity that provides one or more of goods, services, and consultations to individuals such as customers. In some embodiments, the user acknowledgement system 408 may be controlled by a third party on behalf of another business, corporation, individual, partnership. The user acknowledgement system 408 may include one or more servers and computer systems for performing one or more functions associated with products and/or services that the organization provides.

Web server 410 may include a computer system configured to generate and provide one or more websites accessible to customers, as well as any other individuals involved in access system 408's normal operations. Web server 410 may include a computer system configured to receive communications from user device 402 via for example, a mobile application, a chat program, an instant messaging program, a voice-to-text program, an SMS message, email, or any other type or format of written or electronic communication. Web server 410 may have one or more processors 422 and one or more web server databases 424, which may be any suitable repository of website data. Information stored in web server 410 may be accessed (e.g., retrieved, updated, and added to) via local network 412 and/or network 406 by one or more devices or systems of system 400. In some embodiments, web server 410 may host websites or applications that may be accessed by the user device 402. For example, web server 410 may host a financial service provider website that a user device may access by providing an attempted login that are authenticated by the response generation system 320. According to some embodiments, web server 410 may include software tools, similar to those described with respect to user device 402 above, that may allow web server 410 to obtain network identification data from user device 402.

The local network 412 may include any type of computer networking arrangement used to exchange data in a localized area, such as WiFi, Bluetooth™ Ethernet, and other suitable network connections that enable components of the user acknowledgement system 408 to interact with one another and to connect to the network 406 for interacting with components in the system 400 environment. In some embodiments, the local network 412 may include an interface for communicating with or linking to the network 406. In other embodiments, certain components of the user acknowledgement system 408 may communicate via the network 406, without a separate local network 406.

In accordance with certain example implementations of the disclosed technology, the user acknowledgement system 408 may include one or more computer systems configured to compile data from a plurality of sources the response generation system 320, web server 410, and/or the database 416. The response generation system 320 may correlate compiled data, analyze the compiled data, arrange the compiled data, generate derived data based on the compiled data, and store the compiled and derived data in a database such as the database 416. According to some embodiments, the database 416 may be a database associated with an organization and/or a related entity that stores a variety of information relating to customers, transactions, ATM, and business operations. The database 416 may also serve as a back-up storage device and may contain data and information that is also stored on, for example, database 360, as discussed with reference to FIG. 3.

With continued reference to FIG. 4, the call center server 430 may include a computer system configured to receive, process, and route telephone calls and other electronic communications between a customer or user operating a user device 402 and the response generation system 320. The call center server 430 may have one or more processors 432 and one or more call center databases 434, which may be any suitable repository of call center data. Information stored in the call center server 430 may be accessed (e.g., retrieved, updated, and added to) via the local network 412 (and/or network 406) by one or more devices of the system 400. In some embodiments, the call center server processor 432 may be used to implement an interactive voice response (IVR) system that interacts with the user over the phone or via a voice/audio call portion of an associated mobile application on the user device 402.

The agent device 440 may include a telephone or computer. Agent device 440 allows the agent to view and select a personalized response from the one or more personalized responses generated. The agent device may include a display and customized GUI to allow the customer service representative to alter the personalized response generated by the response generation system 320. The agent device may also be able to interface with both the call center server 430 and response generation system 320 over local network 412. The agent device may also be integrated into a system already currently used in call centers.

Although the preceding description describes various functions of a web server 410, a response generation system 320, a database 416, a call center server 430, and agent device 440 in some embodiments, some or all of these functions may be carried out by a single computing device.

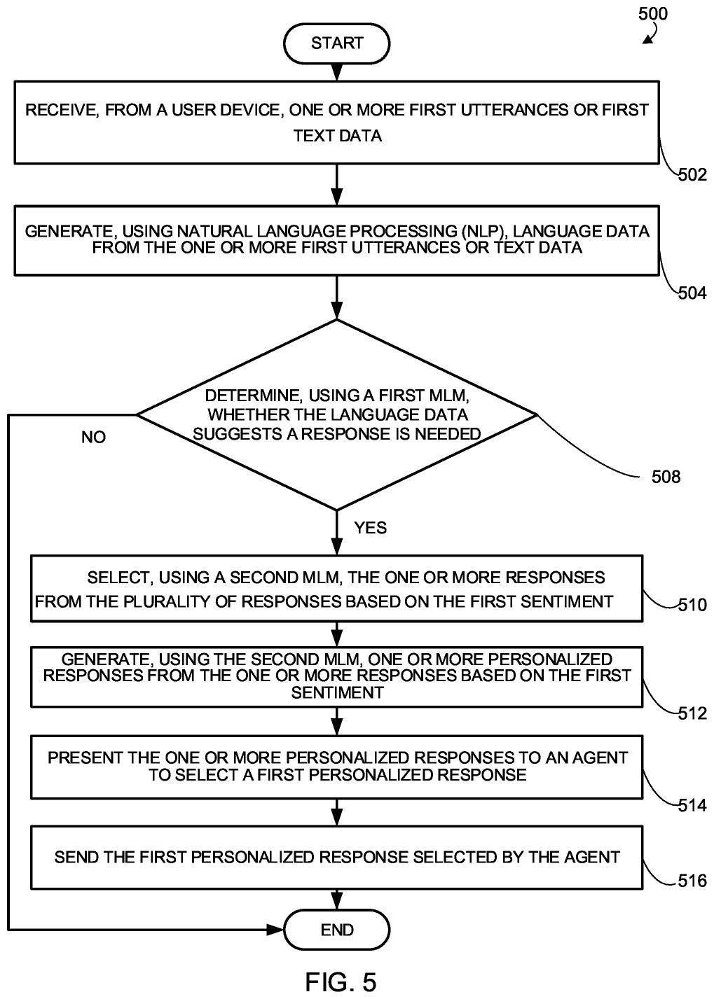

FIG. 5 is a flow diagram illustrating an exemplary method 500 for method for generating a user acknowledgement, in accordance with certain embodiments of the disclosed technology. The steps of method 500 may be performed by one or more components of the system 400 (e.g., response generation system 320 or web server 410 of user acknowledgement system 408 or user device 402), as described in more detail with respect to FIGS. 3 and 4.

Method 500 of FIG. 5 is similar to method 100 of FIG. 1, except that method 500 may not include block 106 of method 100. The descriptions of blocks 502, 504, 510, 512, and 516 in method 500 are similar to the respective descriptions of blocks 102, 104, 110, 112, and 116 of method 100 and are not repeated herein for brevity. However, block 508 is different from block 114 and is described below.

In block 508, the response generation system 320 determines whether the language data suggests a response is needed. The first MLM of response generation system 320 may decide that based on the language data that a response is not necessary (e.g., the user is discussing in passing that his neighbor's extended relative died on the call). If a response is not necessary, the response generation system 320 ends the investigation. If the response generation system 320 determines that a response is necessary (e.g., that a user has lost their job), then the method proceeds to block 510. Factors used by the response generation system 320 to determine if a response is necessary may include, but is not limited to, intonation information in the language data, metrics measuring excitement, and information hinting at the severity of a user's problem.

### Example Use Case

The following example use case describes an example of a typical user flow pattern. This section is intended solely for explanatory purposes and not in limitation.

In one example, a user may be calling, using a phone (e.g., user device 402) to ask for payment relief on a credit card. The call connects to call center server 430. During the call, the user mentions that the reason they are behind on payments is the recent death of their father, which caused the user to miss work. Response generation system 320 receives utterances (e.g., speech) from the call over local network 412. The response generation system 320 then processes the utterances to generate language data. This language data is then interpreted by the first MLM to generate a first sentiment (e.g., the death of a close family member). The first MLM would then determine whether the sentiment requires a response. Since this would be detected to be a significant life event, response generation system 320 would determine that this sentiment requires a response (other significant life events the first MLM would detect would be the user's daughter graduating from college, while life events such as the neighbor's cat being stuck in a tree would not require a response). The response generation system 320 would continue to monitor the call for other information regarding the sentiment.

From there, the response generation system 320 would determine the appropriate response from a plurality of options. In this case, the response generation system 320 would likely determine picking a card is the best option. Several card options would be selected as potential responses. The response generation system 320 would then personalize each of the responses on each of the card by changing the text or graphics (e.g., “Matt, Sorry to hear that your father, Paul, passed away.”) such that at least the user was personally identified. Other relevant information, such as the name of the user's father, and color preferences may be used in association with information on the user's profile pulled from database 416 or transaction information.

Response generation system 320 then would present the best three choices to the customer service representative (e.g., call center agent) on the customer service representative's computer (e.g., agent device 440). The options would be presented in the order that the second MLM believed to match the user's profile the best. The customer service representative would be able to interact with the different options via a dynamic GUI on their computer. The customer service representative would then be able to choose the response that they believed fit the user's situation the best. In this case, the user's situation would necessitate some response. The customer service representative's choice (e.g., a white card with dark blue borders) would then be sent by the response generation system 320 to an appropriate card manufacturer. The information regarding which selection the customer service representative chose is then returned to response generation system 320 to improve future results.

In some examples, disclosed systems or methods may involve one or more of the following clauses:

Clause 1: A method of generating a user acknowledgement, the method comprising: receiving, from a user device, one or more first utterances; generating, using natural language processing (NLP), language data from the one or more first utterances; generating, using a first MLM, a first sentiment based on the language data; determining whether the first sentiment requires one or more responses from a plurality of responses; responsive to the first sentiment requiring the one or more responses: selecting, using a second MLM, the one or more responses from the plurality of responses based on the first sentiment; generating, using the second MLM, one or more personalized responses from the one or more responses based on the first sentiment; sending the one or more personalized responses to an agent device for display for an agent to select a first personalized response; and sending the first personalized response selected by the agent.

Clause 2: The method of clause 1, wherein the one or more personalized responses comprise a greeting card, a flower, a chocolate, or combinations thereof.

Clause 3: The method of clause 1, further comprises receiving one or more second utterances.

Clause 4: The method of clause 3, further comprises generating a second sentiment based on the one or more second utterances, wherein generating the one or more personalized responses is based on the second sentiment.

Clause 5: The method of clause 1, further comprises: obtaining feedback from a user; entering the feedback into the second MLM; and updating the second MLM according to the feedback.

Clause 6: The method of clause 1, wherein: the first personalized response selected by the agent is a greeting card, and sending the first personalized response further comprises: printing the greeting card; and sending the greeting card to a user.

Clause 7: The method of clause 1, wherein: the one or more personalized responses are ranked by the second MLM, and sending the one or more personalized responses to an agent device for display further comprises causing the agent device to display the one or more personalized responses in a ranked order.

Clause 8: The method of clause 7, wherein the second MLM prioritizes the one or more personalized responses based on a transaction history of a user.

Clause 9: The method of clause 1, wherein the second MLM is trained using selection data associated with the agent selecting the first personalized response.

Clause 10: A method of generating a user acknowledgement, the method comprising: receiving, from a user device, first text data; generating, using NLP, language data from the first text data; generating, using a first MLM, a first sentiment based on the language data; determining whether the first sentiment requires one or more responses from a plurality of responses; responsive to the first sentiment requiring the one or more responses: selecting, using a second MLM, the one or more responses from the plurality of responses based on the first sentiment; generating, using the second MLM, one or more personalized responses from the one or more responses based on the first sentiment; presenting the one or more personalized responses to an agent to select a first personalized response; and sending the first personalized response selected by the agent.

Clause 11: The method of clause 10, further comprising: updating a user profile, wherein one or more previous sentiments are stored; and selecting, using the second MLM, the one or more responses from the plurality of responses based on the first sentiment further comprises selecting based on the one or more previous sentiments.

Clause 12: The method of clause 11, wherein selecting, using the second MLM, the one or more responses from the plurality of responses based on the first sentiment further comprises selecting based on a transaction history of a user.

Clause 13: The method of clause 11, wherein: the user profile further comprises one or more previous personalized responses selected by the agent; generating preference predictions based on the one or more previous personalized responses selected by the agent in the user profile; and selecting, using the second MLM, the one or more responses from the plurality of responses based on the first sentiment further comprises prioritizing a response based on preference predictions.

Clause 14: The method of clause 13, wherein selecting, using the second MLM, the one or more responses from the plurality of responses based on the first sentiment further comprises prioritizing a response different from the one or more previous personalized responses selected by the agent.

Clause 15: The method of clause 13, wherein the user profile further comprises the preference predictions for responses based on transaction history.

Clause 16: The method of clause 10, wherein the first sentiment corresponds to a major life event.

Clause 17: The method of clause 10, further comprising updating the first sentiment and the language data in response to receiving additional text data from the user device.

Clause 18: A method of generating a user acknowledgement, the method comprising: receiving, from a user device associated with a user, one or more first utterances; generating, using NLP, language data from the one or more first utterances; generating, using a first MLM, a first sentiment based on the language data; selecting, using a second MLM, one or more responses from a plurality of responses based on the first sentiment; generating, using the second MLM, one or more personalized responses from the one or more responses based on the first sentiment; selecting a first personalized response; and sending the first personalized response.

Clause 19: The method of clause 18, wherein selecting the first personalized response among the one or more personalized responses is based on cost associated with the one or more personalized responses.

Clause 20: The method of clause 18, wherein selecting the one or more responses from the plurality of responses is based on transaction data associated with the user.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of generating a user acknowledgement, the method comprising:
receiving, from a user device, one or more first utterances;
generating, using natural language processing (NLP), language data from the one or more first utterances;
generating, using a first machine learning model (MLM), a first sentiment based on the language data;
determining whether the first sentiment requires one or more responses from a plurality of responses;
responsive to the first sentiment requiring the one or more responses:
selecting, using a second MLM, the one or more responses from the plurality of responses based on the first sentiment;
generating, using the second MLM, one or more personalized responses from the one or more responses based on the first sentiment;
sending the one or more personalized responses to an agent device for display for an agent to select a first personalized response; and
sending the first personalized response selected by the agent.

2. The method of claim 1, wherein the one or more personalized responses comprise a greeting card, a flower, a chocolate, or combinations thereof.

3. The method of claim 1, further comprises receiving one or more second utterances.

4. The method of claim 3, further comprises generating a second sentiment based on the one or more second utterances, wherein generating the one or more personalized responses is based on the second sentiment.

5. The method of claim 1, further comprises:
obtaining feedback from a user;
entering the feedback into the second MLM; and
updating the second MLM according to the feedback.

6. The method of claim 1, wherein:
the first personalized response selected by the agent is a greeting card, and
sending the first personalized response further comprises:
printing the greeting card; and
sending the greeting card to a user.

7. The method of claim 1, wherein:
the one or more personalized responses are ranked by the second MLM, and
sending the one or more personalized responses to an agent device for display further comprises causing the agent device to display the one or more personalized responses in a ranked order.

8. The method of claim 7, wherein the second MLM prioritizes the one or more personalized responses based on a transaction history of a user.

9. The method of claim 1, wherein the second MLM is trained using selection data associated with the agent selecting the first personalized response.

10. A method of generating a user acknowledgement, the method comprising:
receiving, from a user device, first text data;
generating, using NLP, language data from the first text data;
generating, using a first MLM, a first sentiment based on the language data;
determining whether the first sentiment requires one or more responses from a plurality of responses;
responsive to the first sentiment requiring the one or more responses:
selecting, using a second MLM, the one or more responses from the plurality of responses based on the first sentiment;
generating, using the second MLM, one or more personalized responses from the one or more responses based on the first sentiment;
presenting the one or more personalized responses to an agent to select a first personalized response; and
sending the first personalized response selected by the agent.

11. The method of claim 10, further comprising:
updating a user profile, wherein one or more previous sentiments are stored; and
selecting, using the second MLM, the one or more responses from the plurality of responses based on the first sentiment further comprises selecting based on the one or more previous sentiments.

12. The method of claim 11, wherein selecting, using the second MLM, the one or more responses from the plurality of responses based on the first sentiment further comprises selecting based on a transaction history of a user.

13. The method of claim 11, wherein:
the user profile further comprises one or more previous personalized responses selected by the agent;
generating preference predictions based on the one or more previous personalized responses selected by the agent in the user profile; and
selecting, using the second MLM, the one or more responses from the plurality of responses based on the first sentiment further comprises prioritizing a response based on preference predictions.

14. The method of claim 13, wherein selecting, using the second MLM, the one or more responses from the plurality of responses based on the first sentiment further comprises prioritizing a response different from the one or more previous personalized responses selected by the agent.

15. The method of claim 13, wherein the user profile further comprises the preference predictions for responses based on transaction history.

16. The method of claim 10, wherein the first sentiment corresponds to a major life event.

17. The method of claim 10, further comprising updating the first sentiment and the language data in response to receiving additional text data from the user device.

18. A method of generating a user acknowledgement, the method comprising:
receiving, from a user device associated with a user, one or more first utterances;
generating, using NLP, language data from the one or more first utterances;
generating, using a first MLM, a first sentiment based on the language data;
selecting, using a second MLM, one or more responses from a plurality of responses based on the first sentiment;
generating, using the second MLM, one or more personalized responses from the one or more responses based on the first sentiment;
selecting a first personalized response; and
sending the first personalized response.

19. The method of claim 18, wherein selecting the first personalized response among the one or more personalized responses is based on cost associated with the one or more personalized responses.

20. The method of claim 18, wherein selecting the one or more responses from the plurality of responses is based on transaction data associated with the user.
